(19) United States
(12) Patent Application Publication
(10) Pub. No.: US 2018/0106597 A1
(43) Pub. Date: Apr. 19, 2018

(54) Safe Measure

(71) Applicant: Troy A. Reynolds, Denton, TX (US)

(72) Inventor: Troy A. Reynolds, Denton, TX (US)

(21) Appl. No.: 15/782,078

(22) Filed: Oct. 12, 2017

Related U.S. Application Data
(60) Provisional application No. 62/407,561, filed on Oct. 13, 2016.

(51) Int. Cl. G01B 11/02; G01C 9/06; G01S 17/08

(52) U.S. Cl. CPC G01B 11/026; G01S 17/08; G01C 9/06

(57) ABSTRACT

A surface measuring device to measure any dimension of a structure or surface is disclosed. The surface measuring device comprises a housing configured to have a distance measuring module having an array of laser elements and a plurality of sensors to measure a distance to a plane and an angle it exists off horizontal surface. A user interface in the device allows a user to choose the surface to measure the height and width to calculate the area of the surface. An angular position measuring module integrated with the distance measuring module, comprises an electronic inclinometer and an accelerometer to calculate required dimensions. Further, the device comprises a display to facilitate a menu driven method for the user to input and output the required measurements.

### BACKGROUND OF THE INVENTION

### A. Technical Field

The present invention generally relates to a surface measuring device, more particularly, the invention relates to a handheld device for assisting a user in surveying applications. The invention is specifically related to the surface measuring device to measure the dimensions of any structure quickly and safely.

### B. Description of Related Art

Generally, measurement of various dimensions and angles of the structures and surfaces are performed with a help of various tools like levels, calipers, gauges and so on. Manually all the measuring activities are carried out by a user to fetch all the required parameters. In these cases, the measurement accuracy of all the parameters is always below par as this includes manual errors. On the other hand, these measuring tools are expensive and cumbersome which needs expertise skills to carry out all the requirement measurement tasks.

There are certain cases where the user need to measure various parameters of structures and surfaces on high places is always a daunting and unsafe attempt. Therefore, a ladder is always used for assistance where the user has to climb and take precarious positions to accomplish the task. Further, on an even surface, it is always dangerous and challenging for the user to carry out all the measurements.

Presently, if any user like an insurance adjuster, a contractor, or a tradesman is measuring items or buildings, they typically use steel rules or single axis laser measures. These require climbing up and down of ladders, having the tapes blown about by the winds, or having to place targets for the laser measurers. Also, use of the ladders always represents falling and slipping hazards, which results in severe injury or death of the user.

Therefore, there is a need for a safer measuring device as a single unit to assist the user to measure safely and quickly of any dimension of a structure or an object from a proximity

### SUMMARY OF THE INVENTION

The present invention discloses a handheld surface measuring device. In an embodiment, the handheld surface measuring device comprises, a housing, a distance measuring module, an angular position measuring module, a user interface, a trigger means, a controller and a communication module. In one embodiment, the housing comprises a handle and a foot for being hand-held during operation. In one embodiment, the distance measuring module is integrated within the housing. The distance measuring module comprises, an emitter and a receiver. The emitter comprises an array of laser elements with sensors configured to emit a laser beam at a target surface. The receiver is configured to capture the laser beam reflected from the target surface.

In one embodiment, the angular position measuring module integrated with the distance measuring module configured to measure an angle of inclination and rotation from a base reading within ±0.2° reflective to the laser beam. In one embodiment, the user interface is mounted to the housing configured to permit a user to select apparatus operation and to select a required measurement for calculation. In some embodiments, the trigger means is mounted to the housing configured to allow the user to trigger the emission of laser beam onto the target surface to provide a distance measurement of the target surface for calculation of the required measurement.

In one embodiment, the controller module integrated within the housing in communication with the distance measuring module, angular position measuring module, user interface, trigger means, and comprises a processor having memory for storing measurements. The controller module is configured to calculate the required measurement specified by the user, wherein the required measurement depends on the distance measurement of the target surface, and display the calculated measurement to the user via the user interface. In one embodiment, the communication module in communication with the controller module configured to transmit the calculated measurement to one or more user interface separate from the housing.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 shows a surface measuring device to measure a dimension of a structure, according to an embodiment of the present invention.

FIG. 2 shows a front view of the surface measuring device to measure the dimension of the structure, according to the embodiment of the present invention.

FIG. 3 shows a side view of the surface measuring device to measure the dimension of the structure, according to the embodiment of the present invention.

FIG. 4 shows a rear view of the surface measuring device to measure the dimension of the structure, according to the embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

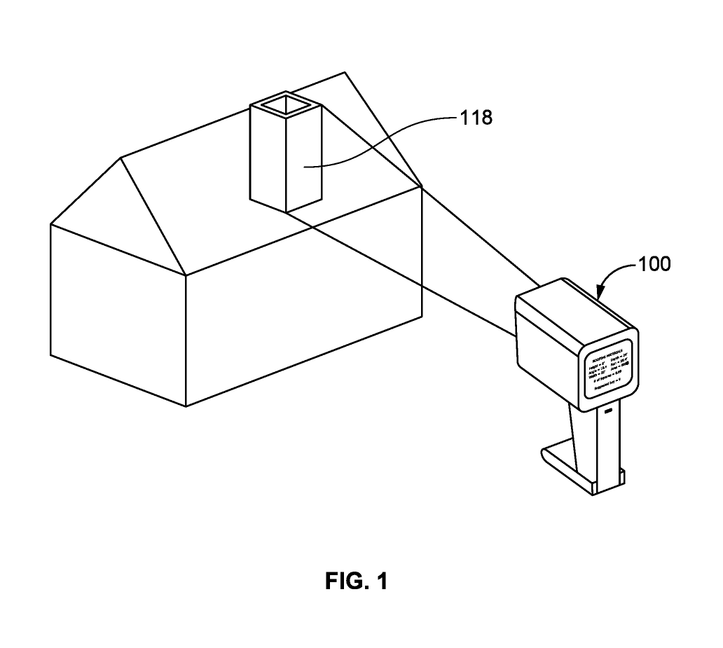

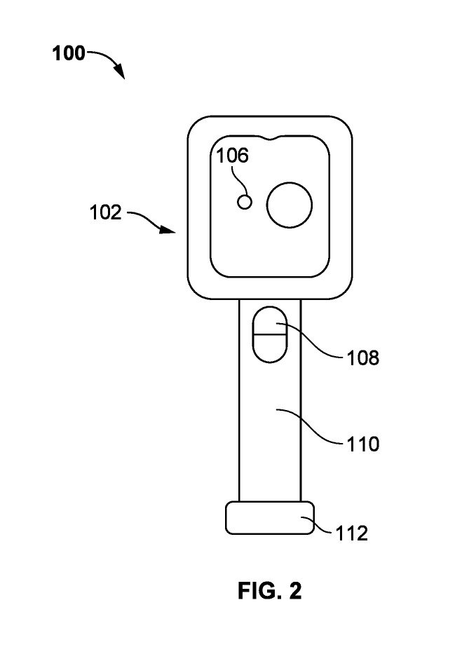

According to FIG. 1, the present invention relates to a surface measuring device 100 for measuring one or more dimensions of a target surface 118, for example, chimney hood of the building structure. The surface measuring device 100 is configured to assist a user to measure a plurality of parameters like a length, a width, an area, a slanted area and other parameters which are hard to measure from the ground. As shown in FIG. 2, the surface measuring device 100 comprises a housing 102 integrated with a distance measuring module 106, comprising an array of laser elements and a plurality of sensors to measure a distance to a plane and an angle it exists off horizontal surface. The array of laser elements is a laser beam configured to send pulses to the specific area of measurement. The distance measuring module 106 is integrated with an angular position measuring module comprising an electronic inclinometer chip and gyroscope/accelerometer on another CMOS chip to determine the derive the angle of inclination and rotation from a base reading within ±0.2°.

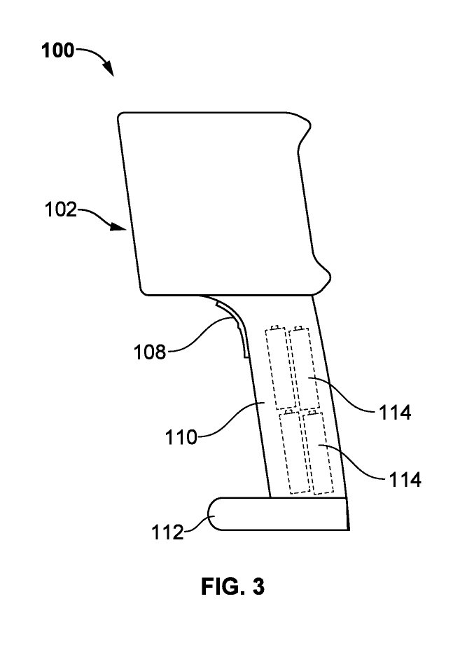

In on embodiment, the distance measuring module 106 comprises a time of flight measurement module. In a preferred embodiment as shown in FIG. 2, the distance measuring module 106 in the surface measuring device 100 comprising, the array of laser emitters configured to measure the time between a pulse sent and the time it takes for the pulse to reflect back from the target surface 118 via a time of flight method as shown in FIG. 1. The receiver captures this pulse and sends it to a processor for further calculation of all the measured variables. In one embodiment, the distance measuring module 106 uses the speed of light as a constant to obtain the distance. The distance measuring module 106 is configured to measure up to a distance of 394′ with accuracies of ± 1/16″ within the first 100′ and slightly larger at or near the full distance. As shown in FIG. 3, the surface measuring device 100 comprises a handle 110, a foot 112 and an electronics pod, which is covered with thick closed cell foam to provide impact resistance, if inadvertently dropped.

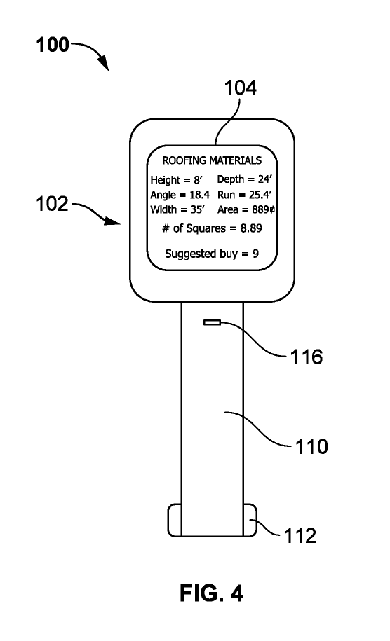

In one embodiment, the surface measuring device 100 comprises a user interface including a display 104 providing a menu driven method for the user to take the required measurements, as shown in FIG. 4. The display 104 is an LED backlit LCD capacitive touchscreen configured to provide up 16 M colors. In an exemplary embodiment, the display 104 comprises a configuration of a 4″ square with 640 by 640 pixels per inch. Further, the screen is protected with replaceable plastic wear resistant panels designed for specific use. The surface measuring device 100 as shown in FIG. 2 and FIG. 3, comprises a trigger means such as trigger button 108 where the user press the button, move and record the distances to provide a basis of various calculations. Once all the dimensions are measured, the results are calculated and shown in the display 104. A user interface in the device 100 allows the user to choose the target surface 118 to measure the height and width to calculate the area of the target surface 118 as shown in FIG. 1. The backlighted touch screen allows the user to enter the menu driven data items, and then displays the results legibly in full color in various lighting conditions. Color (for example, red, etc.) laser spot enhancing glasses are provided to the user for enhanced view during the bright sunlight day. The acquired data is also downloaded using a small lightning connector 116 as shown in FIG. 3 and the supplied cable.

In one embodiment, the surface measuring device 100 manufactured in a durable plastic housing 102 covered by foam for protection, in case, it is inadvertently dropped during use, as shown in FIG. 2. In a different embodiment, a method of manufacturing the plastic housing 102 is also disclosed. The housing 102 is injection molded in two sections from polycarbonate plastic. The housing 102 are snapped together using a modified casket seal and are secured using various stainless-steel fasteners. A plurality of tabs and bulkheads within the housing 102 provide support for the various electronics and mechanical switches. Once fabrication is done, the EVA closed cell foam is molded to fit snugly around the housing 102 and protecting it from drop shocks up to 4′ onto concrete. The housing 102 and foam is supplied in almost any vibrant color, so a distinctive color combination are chosen to enhance the product recognition factor.

In one embodiment, the surface measuring device 100 comprises a printed circuit board unit protected with a moisture adsorption preventive conformal coating, as shown in FIG. 4. The surface measuring device 100 further comprises a controller module having a 1.2 GHz processor with an operating system. The processor comprises a battery backup for launch programs and other vital data and incase if there is no power, the device 100 automatically goes to sleep mode in an orderly fashion. The surface measuring device 100 also has a communication module comprising a Bluetooth compatibility for communication with a plurality of external devices. In one embodiment, the external devices at least one of a smartphone, laptop, computer, tablet computers, personnel computers and personnel digital assistants. A USB cable with a lightning connector 116 is supplied for software and firmware updates. The cable is also used for connecting to the external user interface devices incorporated with the software application. The measurement software in the surface measuring device 100 is configured to be updated based on user requirements and application enhancement. Also, the commercially available cellular phone module is supplied in either GSM or CDMA, whichever the manufacturer chooses to use.

In some embodiments, the device 100 is configured to link one or more external user interface devices such as printer via on-board Bluetooth communication to print the document, or link with the cellular phone. The surface measuring device 100 comprises a memory unit, for example, 6 GB of memory, to store a plurality of data for later retrieval and usage. In one embodiment, the device 100 comprises a power supply module, which provides electrical power to the device 100, said electrical power being disabled when the device 100 is not in use. According to FIG. 3, the power supply module comprises one or more replaceable batteries 114. The surface measuring device 100 is powered with 4 AA replaceable batteries 114, which provides sufficient power to operate the device 100.

In one embodiment, the controller unit or module in communication with the distance measuring module 106, angular position measuring module, user interface, trigger means, comprises the processor and memory unit. The memory is configured to store the measurement data from the various modules of the device 100. The controller module is configured to calculate the desired measurement specified by the user utilizing the data from the distance measuring module 106 and angular position measuring module.

In an exemplary embodiment, a method of using the surface measuring device 100 is disclosed, as shown in FIG. 1. In one example, the method comprising the steps of: the user if requires the number of bundles of shingles required to cover one side of a 35′-wide roof that is made at a 4-12 pitch, the user selects roofing from the menu on the display 104 as shown in FIG. 4, and then select ‘number of squares’ from the sub-menu. The device 100 measures at the edge of the roof, one roughly half way up the pitch, and one at the peak and determines from these measurements that the pitch is 4-12 and the depth is 24′ which results in a 25.4′ hypotenuse measurement. Further, the device prompts the user to acquire a measurement at the lower left corner and one at the lower right corner of the roof to get the width of 35′. Once these data points are input, the area is calculated (35′ W×25.4′ hyp=889′), the number of squares are determined (divide by 100′ per square), and the output result, 8.89 is displayed. The results are printed or transferred to any external user interface via the integrated Bluetooth device. All these dimensions of the structure or surface are measured safely from the proximal ground, providing a quick and accurate measurement with no physical risk.

In a different embodiment, the fabrication of PCB for the surface measuring device 100 is disclosed. The standard thickness, double sided FR4 circuit board material is populated with surface mounted components and IC chips. Any through-hole devices are inserted once the surface mounted assembly is soldered and cleaned. Both circuit boards are designed to have all the components oriented, so the PCB is mounted with the LED illuminators projecting out of the lenses mounted in the housing 102. Finally, the PCBs are protected with a moisture adsorption preventive conformal coating.

According to the present invention, the surface measuring device 100 is very durable, is highly resistant to drop shocks during the usage. It is designed to be aesthetic in appearance and effective in the application and relatively uncomplicated fabrication and the reasonably priced components provide good marketability for the manufacturer. The user can benefit from improved measurement, safety, and construction based calculations, which should provide considerable market interest in the product. The surface measuring device 100 measures roof angles, heights, widths, etc. from a single location on the ground, providing optimum safety, and accurate measurement to the user. The vibrant and distinctive color combination for the surface measuring device 100 is chosen to enhance the product recognition factor. The surface measuring device 100 helps the user to just point and click to find critical dimensions of walls, roof tops and anything else that to be measured. The surface measuring device 100 also measures multiple distances from different angles providing all required parameters for the user, without taking any extended risks to accomplish the task.

Although a single embodiment of the invention has been illustrated in the accompanying drawings and described in the above detailed description, it will be understood that the invention is not limited to the embodiment developed herein, but is capable of numerous rearrangements, modifications, substitutions of parts and elements without departing from the spirit and scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A handheld surface measuring device, comprising:
a housing having a handle and a foot for being hand-held during operation;
a distance measuring module integrated within the housing comprises:
an emitter having an array of laser elements with sensors configured to emit a laser beam at a target surface, and
a receiver configured to capture the laser beam reflected from the target surface;
a user interface mounted to the housing configured to permit a user to select apparatus operation and to select a required measurement for calculation;
a trigger means mounted to the housing configured to permit the user to trigger the emission of laser beam onto the target surface to input a distance measurement of the target surface for calculation of the required measurement;
a controller module integrated within the housing in communication with the distance measuring module, user interface, trigger means, comprises a processor having memory for storing measurements, wherein the controller module is configured to:
calculate the required measurement specified by the user, wherein the required measurement depends on the distance measurement of the target surface and
display the calculated measurement to the user via the user interface, and
a communication module in communication with the controller module configured to transmit the calculated measurement to one or more external user interface separate from the housing.

2. The device of claim 1, further comprising an angular position measuring module integrated with the distance measuring module configured to measure an angle of inclination and rotation from a base reading within ±0.2° reflective to the laser beam.

3. The device of claim 1, wherein the housing is made of durable plastic covered with foam.

4. The device of claim 1, wherein the user interface is a touch screen display.

5. The device of claim 1, wherein the angular position measuring module comprises an inclinometer.

6. The device of claim 1, wherein the angular position measuring module comprises an accelerometer.

7. The device of claim 1, wherein the distance measuring module comprises a time of flight measurement module.

8. The device of claim 1, further comprising a power supply module to provide electrical power to the device.

9. The device of claim 7, wherein the power supply module comprises one or more replaceable batteries.

10. The device of claim 1, further comprises a lightening connector mounted on the housing in communication with the controller module permits the user to download the calculated measurement.

11. The device of claim 1, wherein the communication module comprises a wired or a wireless communication module.

12. The device of claim 1, wherein the communication module comprises a Bluetooth module.

13. The device of claim 1, wherein the user interface separate from the housing is at least one of a smartphone, laptop, computer, tablet computers, personnel computers and personnel digital assistants.
